(19) United States
(12) Patent Application Publication
(10) Pub. No.: US 2024/0323379 A1
(43) Pub. Date: Sep. 26, 2024

(54) Method and Device for Designing a Bit Rate Ladder for Video Streaming

(71) Applicant: Hochschule RheinMain, Wiesbaden (DE)

(72) Inventors: Matthias Narroschke, Schaafheim (DE); Andreas Kah, Kelsterbach (DE); Wolfgang Ruppel, Frankfurt (DE)

(21) Appl. No.: 18/579,001

(22) PCT Filed: Jul. 13, 2022
(86) PCT No.: PCT/EP2022/069611

§ 371 Date: Jan. 12, 2024

(30) Foreign Application Priority Data
Jul. 14, 2021 (DE) 10 2021 118 216.6

(51) Int. Cl. H04N 19/124; H04N 19/154; H04N 19/593

(52) U.S. Cl. CPC H04N 19/124; H04N 19/154; H04N 19/593

(57) ABSTRACT

The present invention relates to methods and devices for determining a set of quality levels and to encoding representations of a video section. Determining a set of quality levels for the respective associated representations of a video section takes special consideration of the resulting subjective quality during creation. This is described primarily by quality-based parameters. They are the highest and lowest quality and the quality level among the individual representations.

### CROSS-REFERENCE TO RELATED APPLICATIONS

This application is the United States national phase of International Application No. PCT/EP2022/069611 filed Jul. 13, 2022, and claims priority to German Patent Application No. 10 2021 118 216.6 filed Jul. 14, 2021, the disclosures of each of which are hereby incorporated by reference in their entireties.

### BACKGROUND OF THE INVENTION

### Field of the Invention

The present invention relates to methods and devices for providing quality levels for determining a bit rate ladder for video streaming.

### Description of Related Art

When transmitting video data, the quality of the video depends on the bit rate. The amount of data that is necessary to display a short-running video can be so large that difficulties in data transmission over networks with limited bandwidth can arise. Examples of this include broadcasting a digital television program and image/video transmission via the Internet or mobile networks.

Despite the usual compression of image or video data before it is stored or transmitted over a network, the amount of data of a quality of the video often cannot be reduced sufficiently for networks with limited bandwidth.

Streaming services therefore typically provide several versions of the same video, each with a different quality level. These different versions of the same video are also referred to as representations of a video. They have bit rates that differ from each other. The different bit rates are obtained by different settings of the coding parameters at the encoder. For example, the quantization step can be set differently for different representations.

### SUMMARY OF THE INVENTION

Since the desired image quality should be as high as possible, it is therefore desirable to adapt the selection of the bit rate to the bandwidth available to the user without having to accept significant losses in image quality. It is therefore an object of the present invention to provide quality levels for a bit rate ladder which can be used to encode videos to a plurality of representations.

This object is satisfied by the disclosure herein and includes advantageous embodiments.

Some embodiments of the present invention allow for a set of representations of video sections to be created such that the maximum difference in quality is minimized in a quality measure while taking into account the costs for encoding and storage.

According to a first aspect, the present invention relates to a method for determining quality specifications for encoding representations of a video section. The method comprises determining a maximum quality level and a minimum quality level based on a quality measure. The method further comprises determining a set of quality levels for the respective associated representations of a video section, consisting of two or more quality levels that maintain a predefined maximum quality gap between adjacent quality levels, where the set of quality levels contains a quality level above or equal to the maximum quality level and contains a quality level below or equal to the minimum quality level.

According to an embodiment of the present invention, the minimum quality level can be determined based on an acceptance measure which indicates a minimum quality at which a predetermined number of viewers find the representation associated with the minimum quality to be acceptable.

In one embodiment, the maximum quality level can be determined based on a quality at which a predetermined number of viewers cannot distinguish the representation corresponding to the quality from an original representation.

For example, a minimum number of quality levels can be determined by the maximum quality level, the minimum quality level, and the maximum quality gap.

In one embodiment, adjacent quality levels that differ by the maximum quality gap can be classified by a predetermined number of viewers as being subjectively equal.

According to one embodiment, the quality measure can be an estimate of a subjective video metric.

For example, the quality measure can be a Video Multi-Method Assessment Fusion (VMAF) metric.

In one embodiment, the maximum quality gap in the VMAF metric can be 2 and/or the maximum quality level in the VMAF metric can be 95 and/or the minimum quality level in the VMAF metric can be 55.

In a second aspect, the present invention further relates to a method for encoding representations of a video section. The method comprises the above-mentioned determining of quality specifications. The method further comprises determining one or more encoding parameters for each quality level in the set such that the representation of a video section, after encoding with one or more encoding parameters, substantially reaches the quality level associated with the representation of the video section.

According to an advantageous embodiment, a computer program is provided comprising program instructions which are stored on a non-transferable computer-readable medium and which, when executed on one or more processors, cause the one or more processors to perform the steps of one of the methods mentioned above.

According to a third aspect, the present invention further relates to a device for determining quality specifications for encoding representations of a video section. The device comprises a unit for determining a maximum quality level and a minimum quality level based on a quality measure. The device further comprises a unit for determining a set of quality levels for the respective associated representations of a video section, consisting of two or more quality levels that maintain a predefined maximum quality gap between adjacent quality levels, where the set of quality levels contains a quality level above or equal to the maximum quality level and contains a quality level below or equal to the minimum quality level.

In a fourth aspect, the present invention relates to a device for encoding representations of a video section. The device comprises an above-mentioned device for determining quality specifications. The device furthermore comprises a unit for determining one or more encoding parameters for each quality level in the set such that the representation of a video section, after encoding with one or more encoding parameters, substantially reaches the quality level associated with the representation of the video section.

Additional advantages and benefits of the present invention shall become apparent from the detailed description of a preferred embodiment and the drawings.

### BRIEF DESCRIPTION OF THE DRAWINGS

The terms Fig., Figs., Figure, and Figures are used interchangeably in the specification to refer to the corresponding figures in the drawings.

FIG. 1A shows a block diagram of an exemplary device for determining a bit rate ladder.

FIG. 1B shows exemplary relationships between the bit rate and the quality.

FIG. 2 shows examples of loss of quality and maximum loss of quality in a quality bit rate diagram.

FIG. 3 shows an exemplary classification into quality levels.

FIG. 4 shows the exemplary determining of the maximum quality level.

FIG. 5a shows examples of the acceptance rate and the VMAF score for video sections longer than 30 seconds.

FIG. 5b shows examples of the acceptance rate and the VMAF score for video sections shorter than 30 seconds.

FIG. 6 shows an exemplary flowchart for determining a set of quality levels.

FIG. 7 shows the dependency determined between MOS and VMAF score.

FIG. 8 shows the exemplary determining of the maximum loss of quality.

FIG. 9 shows an exemplary classification into quality levels based on the VMAF score.

FIG. 10 shows an exemplary flowchart for encoding video sections.

FIG. 11 shows an exemplary device that can execute program instructions.

### DESCRIPTION OF THE INVENTION

An embodiment of the present invention shall be described hereinafter in detail with reference to the drawings.

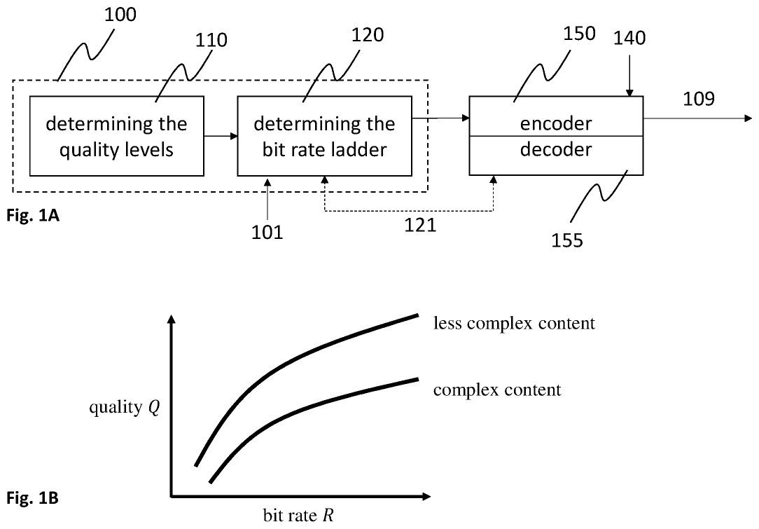

FIG. 1A shows a device 100 for determining a bit rate ladder that can be used to encode a video sequence 140 into a plurality of representations 109 of different quality levels. Such a bit rate ladder can be determined once and then used as a template for encoding a plurality of video sequences. Coding is carried out by encoder 150. Encoder 150 can be a standardized encoder, such as H.264/AVC (Advanced Video Coding), H.265/HEVC (High-Efficiency Video Coding), H.266/VVC (Versatile Video Coding). The present invention can be used with any encoder as long as it can be parameterized so that a desired bit rate and/or quality of the coded video sequence can be set using one or more coding parameters.

A video sequence 140 is a sequence of a plurality (two or more) of images which can also be referred to as “video” or “video signal” for short. The term “video section” is also used hereinafter to emphasize that a video sequence to be encoded, for example a film, does not necessarily have to be encoded in its entirety, but rather in one or more sections. On the one hand, a video section can be a temporal section, i.e. a subset of the total number of images in a video sequence. However, a video section can instead or in addition be a spatial section, e.g., be a subpicture of an overall picture.

Device 100 for determining a bit rate ladder can include a device 110 for determining the quality levels. Quality is there measured using a predefined quality metric. Preferably, the quality metric has a correlation to the quality perceived by viewers. Determining the quality levels comprises determining a quality range in which the majority of representations should be disposed and the levels themselves (number and/or distribution of levels in the quality range).

Once the quality levels have been determined, the bit rate ladder can be determined in a device 120 based on the quality levels determined. This can be done, for example, for a specific codec. In general, however, it is also possible to use different codecs for certain quality levels.

A bit rate ladder is a set of bit rates corresponding to respective predetermined quality levels (in device 110). For example, a bit rate in the bit rate ladder is determined such that it leads to one of the quality levels. A bit rate presently refers to the bit rate of an encoded video sequence (or of a video section). A specific codec or encoder 150 typically allows for the bit rate to be adjusted. The bit rate ladder can therefore be determined in that different bit rate settings are tested. The video is encoded with each of the bit rate settings and the quality is determined. Then those bit rates are selected whose qualities come closest to the predetermined quality levels. In FIG. 1A, this search for bit rates is represented by loop 121-device 120 configures the bit rate settings and the video sections to be encoded for encoder 150, and encoder 150 outputs an encoded bit stream which is decoded by a decoder 155. The quality of the decoded video section is determined. Determining the quality can still take place in decoder 155 or in device 120 based on the decoded video section.

It is to be noted that different video sequences (e.g. with different content) can lead to different qualities after encoding and decoding (also known as reconstruction), even with the same bit rate setting. Therefore, the bit ladder can be determined on the basis of a plurality of coded video sections 101 (provided as input 140 of encoder 150). In addition, an encoder 150 does not need to directly support an input of the bit rate. The bit rate can be set indirectly, e.g. by setting the resolution of the video, the quantization step, the bit depth, or by way of other coding parameters. The above-mentioned devices are functional and can all be implemented in any software and/or hardware. Streaming services use adaptive bit rates (ABR) to offer different quality levels of video signals to end users with different bandwidths. With ABR streaming, the video signal is encoded in different bit rates R₁, . . . , Rₖ, . . . , R_{K}. These different bit rates R₁, . . . , Rₖ, . . . , R_{K} correspond to different quality levels Q₁, . . . , Qₖ, . . . , Q_{K}. An encoded video signal of a certain bit rate and associated quality level is a representation (Rₖ, Qₖ) and the set of all K representations (R₁, Q₁), . . . , (R_{K}, Q_{K}) is a bit rate ladder.

The quality Q of a digital video signal increases with the bit rate K, as illustrated in FIG. 1B. Furthermore, the quality associated with a bit rate can depend on the content of the video section. More complex content of a video signal with low redundancy typically has a lower quality than content with higher redundancy at the same bit rate.

If predefined bit rates are used for all video content to create a bit rate ladder, then this results in data rate or memory being wasted for less complex content. It can also happen that, with more complex content, a data rate not high enough is provided and this leads to a reduction in the subjective quality (perceived by viewers (users)).

Content-dependent bit rate ladders can be optimized for complete video content, such as a complete film (per-title encoding) or for finer subdivisions, e.g. for video sections, e.g. individual scenes of a film (per-scene encoding). By taking the resulting quality into account, data rates and storage space can be saved.

For example, the K bit rates in the bit rate ladder are sorted as follows: R₁< . . . <R_{K}< . . . <R_{K}. As a result, Q₁< . . . <Qₖ< . . . <Q_{K} applies to the associated quality levels. Each end-user device can request and stream content from a content delivery network (CDN) at a bit rate suitable for the individual transmission rate T of the user's Internet connection. There are a number of possible selection strategies for a suitable bit rate. For example, the highest possible bit rate that is lower than the individual transmission rate T can be selected, i.e.

$${R}_{p} ( T ) = {max}_{k = 1 , … , K \vert {R}_{k} \leq T} {R}_{k} .$$

Furthermore, it is possible, for example, to switch between different representations, e.g. (Rₚ, Qₚ) and (Rₚ₊₁, Qₚ₊₁) in order to efficiently use the transmission rate available. However, the present invention is not restricted to these examples.

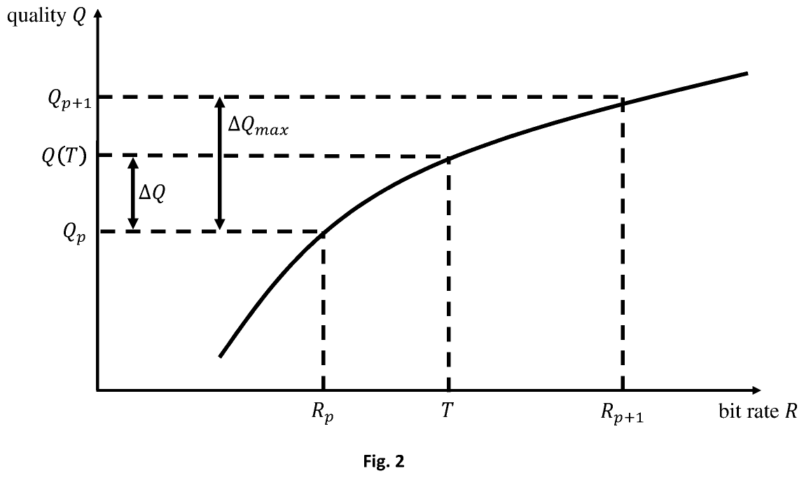

When using a set of representations with discrete bit rates R₁, . . . , Rₖ, . . . , R_{K}, the streamed video has a lower quality if the individual transmission rate T is not contained in the set R₁, . . . , Rₖ, . . . , R_{K}. This difference defines the loss of quality

$$Δ Q ( T ) = Q ( T ) - Q ( {R}_{p} ( T ) ) ,$$

where Q(T) denotes the quality level that the user could receive based on their individual transmission rate, and Q(Rₚ(T)) denotes the maximum quality level that the user can receive based on the discrete set of representations. This loss of quality is shown by way of example in FIG. 2.

In addition, a maximum loss of quality ΔQₘₐₓ can be defined. This maximum loss of quality identifies the difference in quality between two successive bit rates Rₚ und Rₚ₊₁ with the associated quality levels Qₚ and Qₚ₊₁),

$$Δ {Q}_{m ax} ( {Q}_{p} , {Q}_{p + 1} ) = {Q}_{p + 1} - {Q}_{p} .$$

FIG. 2 shows an example of such a maximum loss of quality. If there are significant differences between the quality levels of successive representations, a loss of quality ΔQ(T) can lead to a significant subjective loss of quality.

A large number of representations are necessary to minimize the maximum loss of quality for all users, for users of low bandwidths, e.g. in mobile networks, as well as users of high bandwidths, e.g. in connections via fiber optic cables, are to be taken into account. However, this results in high costs for operators for coding and storage. Accordingly, the maximum loss of quality should be minimized in a quality measure taking into account the costs for encoding and storage.

In order to automate the creation of the set of representations, the subjective user perception is estimated using a quality measure. Such a quality measure can be an estimate of a subjective video metric. Examples of a quality measure are VMAF, ITU P1203 or the structural similarity index (SSIM). However, the present invention is not restricted to the use of the examples mentioned and other as well as non-standard quality measures can be used.

For example, the quality measure can be a Video Multi-Method Assessment Fusion (VMAF) metric. The VMAF metric is an objective metric for the algorithmic evaluation of image quality in videos. It evaluates a video that has been changed (for example by recoding) based on a comparison with an unimpaired reference (original) in the form of a DMOS estimate (differential mean opinion score, DMOS).

The VMAF metric assigns a score between 0 and 100 to a video signal. A score of 0 corresponds to low subjective quality, a score of 100 corresponds to high subjective quality. The average value of the VMAF scores of all frames of a video signal is hereinafter defined as the VMAF score of the video signal. Quality Q corresponds to the VMAF score VMAF. This gives rise to the difference in quality

$$Δ V M A F ( T ) = V M A F ( T ) - V M A F ( {R}_{p} ( T ) ) .$$

A bit rate ladder consisting of a set of representations can be created using such a quality measure such that a predefined maximum loss of quality between adjacent quality levels is maintained.

A minimum quality level Qₘᵢₙ and a maximum quality level Qₘₐₓ are determined using a quality measure. A set of quality levels is created based on the minimum or maximum quality level. This set of quality levels consists of K quality levels. Where K≥2 applies.

The lowest quality level Q₁ is below the minimum quality level Qₘᵢₙ or is equal to the minimum quality level Qₘᵢₙ·Q₁≤Qₘᵢₙ applies. The highest quality level Q_{K} is above the maximum quality level Qₘₐₓ or is equal to the maximum quality level Qₘₐₓ. Q_{K}≥Qₘₐₓ applies.

In other words, the range of values between the lowest and highest quality levels Q₁≤Qₘᵢₙ<Qₖ<Qₘₐₓ≤Q_{K} is divided into sections that do not exceed the maximum difference in quality. The maximum difference in quality between each pair of directly consecutive representations (Rₖ, Qₖ) and (Rₖ₊₁, Qₖ₊₁) is less than or equal to ΔQₘₐₓ for all transmission rates T in the value range R₁≤T≤R_{K}.

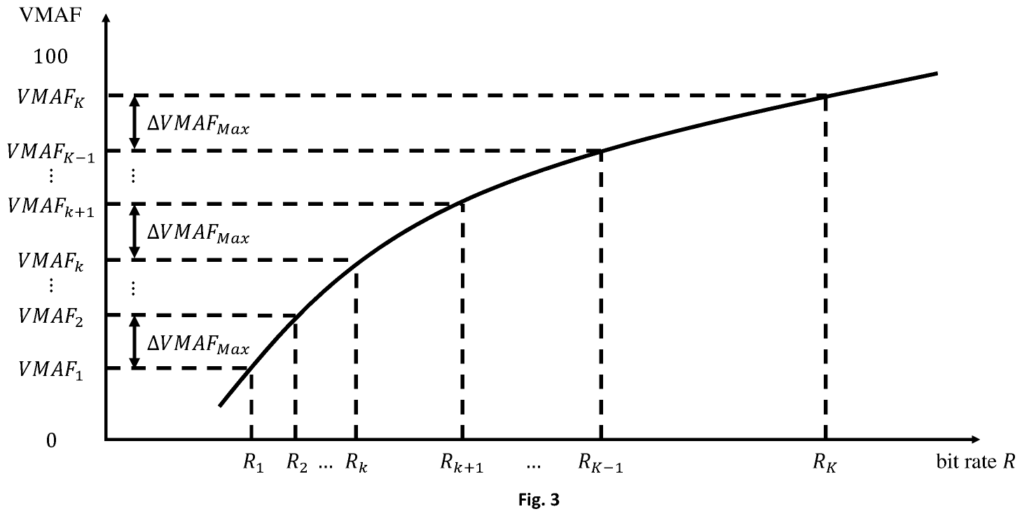

The classification based on such a maximum difference in quality is shown in FIG. 3 by way of example of a VMAF score.

The maximum quality level can be determined based on a quality at which a predetermined number of viewers cannot distinguish the representation corresponding to the quality from an original representation.

The predetermined number of viewers can arise from standardized testing methods. An example is the well-known and standardized “Double Stimulus Impairment” test method according to ITU-R BT.500 (ITU-R., “Rec. BT.500-14: Methodologies for the subjective assessment of the quality of television images” (2019)). However, the present invention is not restricted to the use of the example mentioned. Another methodology can be determined and applied.

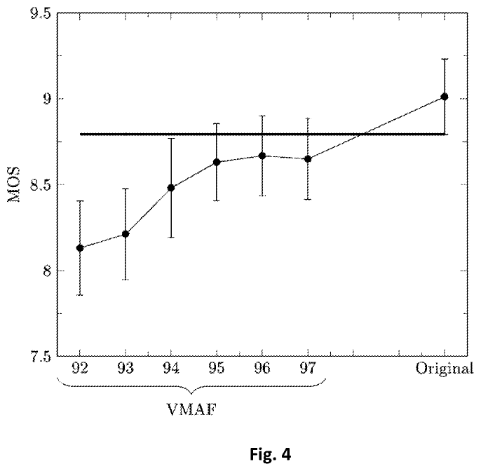

FIG. 4 shows the exemplary determining of the maximum quality level. In order to obtain a possible set of scores on the VMAF scale, tests were carried out with test persons. Based on the determined mean opinion score (MOS) for various VMAF scores of test video sequences, an example of the lowest possible maximum quality level is obtained by a VMAF score of 95. In this example, the MOS is given on a scale between 0 (very annoying impairments) and 10 (imperceptible impairments).

The minimum quality level Qₘᵢₙ can be determined by way of an acceptance measure. This acceptance measure can indicate a minimum quality at which a predetermined number of viewers find the representation associated with the minimum quality acceptable.

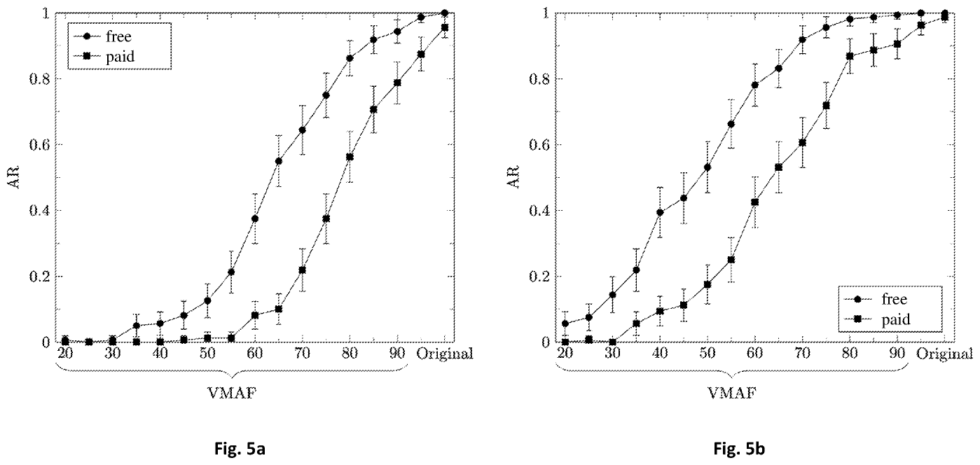

The exemplary determining of the maximum quality level is shown in FIGS. 5a and b. FIG. 5a shows an acceptance rate by way of example for video sequences longer than 30 seconds. A distinction is made between free and paid streaming offers. FIG. 5a shows an acceptance rate by way of example for video sequences shorter than 30 seconds. Acceptance is indicated as 0 (unacceptable subjective quality) or 1 (acceptable subjective quality). The acceptance rate is the average value for all test persons.

If an acceptance rate of 0.5 is demanded, then this resulted in a possible minimum quality level of 55 on the VMAF scale. This lower limit can change based on additional criteria. For example, the minimum score on the VMAF scale for a first streaming service should be 10 to 15 higher than for a second streaming service. If video sequences longer than 30 seconds are at issue, then the minimum VMAF quality level should be 70 for second-tier streaming services or 85 for first-tier streaming services. The first and the second streaming services can be paid or free streaming services, but do not have to be paid or free streaming services.

A minimum number of quality levels can be determined by the maximum quality level, the minimum quality level, and the maximum quality gap. The minimum number can arise from the creation of the quality levels.

The creation of the set of quality levels is shown by way of example in FIG. 6. First, a minimum and a maximum quality level are determined S610.

Starting out from the maximum quality level Qₘₐₓ, the nearest higher quality level Q_{K}≥Qₘₐₓ is selected S620 for which a representation with an associated bit rate R_{K} exists. Starting with the representation (R_{K}, Q_{K}), that representation (R_{K-1}, Q_{K-1}) from a plurality of possible representations is included in the set of representations S630 which has a difference in quality to the highest quality level Q_{K} smaller than or equal to ΔQₘₐₓ.

Starting out from the preceding representation (Rₖ₊₁, Qₖ₊₁), the respective subsequent representation (Rₖ, Qₖ) can be determined (No in S640), by including in the set of representations that representation (Rₖ, Qₖ) from several possible representations which has a difference in quality to the preceding quality level Qₖ₊₁ less than or equal to ΔQₘₐₓ.

This pattern is continued until a minimum quality level Qₘᵢₙ, which is determined based on an acceptance measure as described above, has been reached or undercut (Yes in S640). The lowest quality level in the set of quality levels is therefore Q₁≤Qₘᵢₙ.

The set of representations can also be created starting out from a minimum quality level Qₘᵢₙ. The next smaller quality level Q₁≤Qₘᵢₙ, for which a representation (R₁, Q₁) exists, can be selected as the starting level. The set of quality levels for the associated representations is determined by selecting the next higher quality level Qₖ from a plurality of possible representations such that the difference in quality to the preceding quality level Qₖ₋₁ is less than or equal to ΔQₘₐₓ. This can be continued until the maximum quality level Qₘₐₓ has been reached or exceeded.

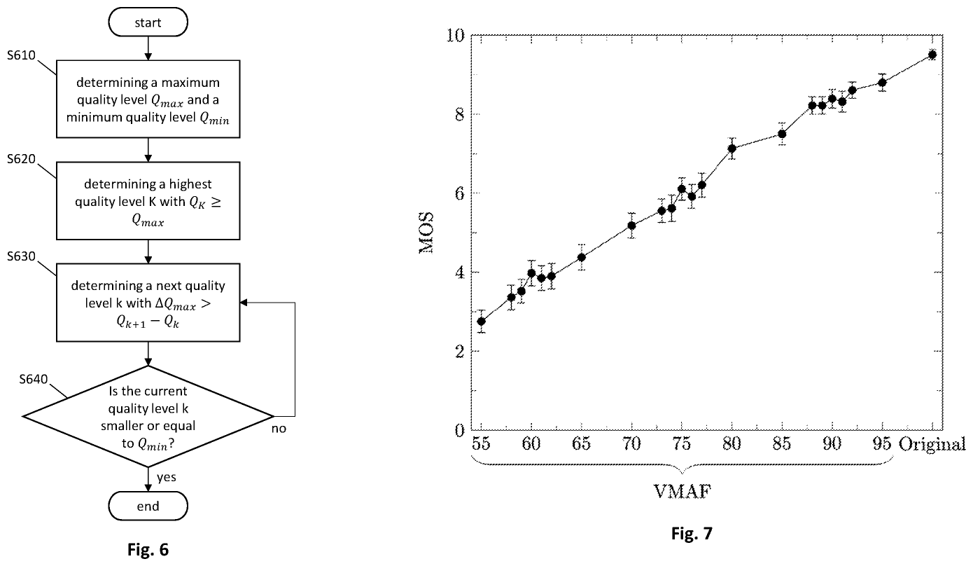

An established relationship between the VMAF score and the MOS is approximately linear, justifying a constant maximum quality gap for all neighboring pairs in the set of representations. This approximately linear relationship is shown by way of example in FIG. 7 in a MOS-VMAF diagram.

The maximum difference in quality can be chosen such that a subjective quality of the video signal for Rₖ and Rₖ₊₁ is the same for a predetermined number of viewers. To determine the maximum difference in quality ΔQₘₐₓ, all pairs of the VMAF score and the associated opinion score (OS) can be evaluated using the VMAF metric as an example. The lower VMAF score is given as VMAFₗ and the higher VMAF score is given as VMAFₕ. This results in values for maximum differences in quality

$$Δ V M A {F}_{m ax} = V M A {F}_{h} - V M A {F}_{l}$$

and the associated differences in opinion scores (differential opinion score, DOS)

$$DOS ( Δ V M A {F}_{ma x} ) = OS ( V M A {F}_{h} ) - OS ( V M A {F}_{l} ) .$$

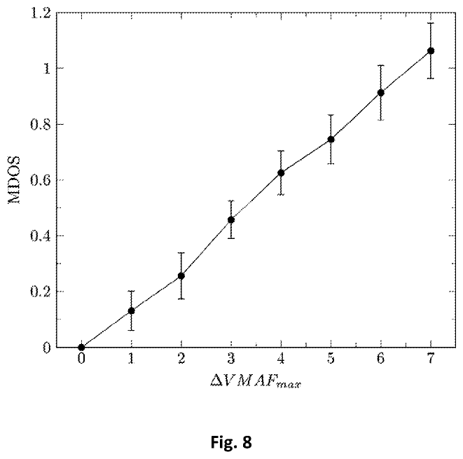

FIG. 8 shows the exemplary determining of the maximum quality level. The diagram shows the average value of the DOS values (MDOS). A gap of 2 on the VMAF scale can arise as the maximum quality gap if the confidence interval does not overlap with an MDOS value of 0.5.

There are at least 21 quality levels for a maximum quality level of 95 on the VMAF scale, a minimum quality level of 55, and a maximum quality gap of 2. However, the present invention is not restricted to the use of the exemplary values mentioned. Using a different quality measure can result in different values.

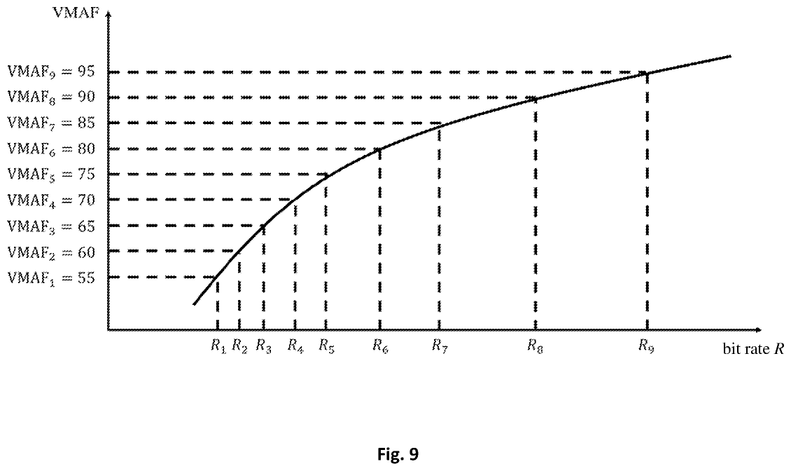

FIG. 9 shows an exemplary division in a VMAF bit rate diagram. For reasons of clarity, a maximum quality gap of 5 on the VMAF scale was chosen in this example. In this example, nine quality levels in the value range arise which comprises the minimum and maximum quality levels. However, this exemplary representation does not represent an ideal set of quality levels because differences in quality can be noticeable between levels.

Coding of a video section based on quality specifications is shown by way of example in FIG. 10. After determining the quality specifications as described above S1010, one or more coding parameters are determined for each quality level in the set of quality levels S1020. After encoding S1030 with the one or more encoding parameters, a video section substantially reaches the associated quality level (Yes in S1040). This means that the associated quality level has been reached on average for several different video sections. If the encoded video section does not reach the required quality (No in S1040), one or more new coding parameters can be created and the video section can be encoded (S1030). Different sets consisting of one or more coding parameters can be created. That set whose quality level reached is as close as possible to the desired quality level is selected.

Although the embodiments of the invention have been described based on encoding video data, the invention is not restricted thereto but can also be used for encoding still images.

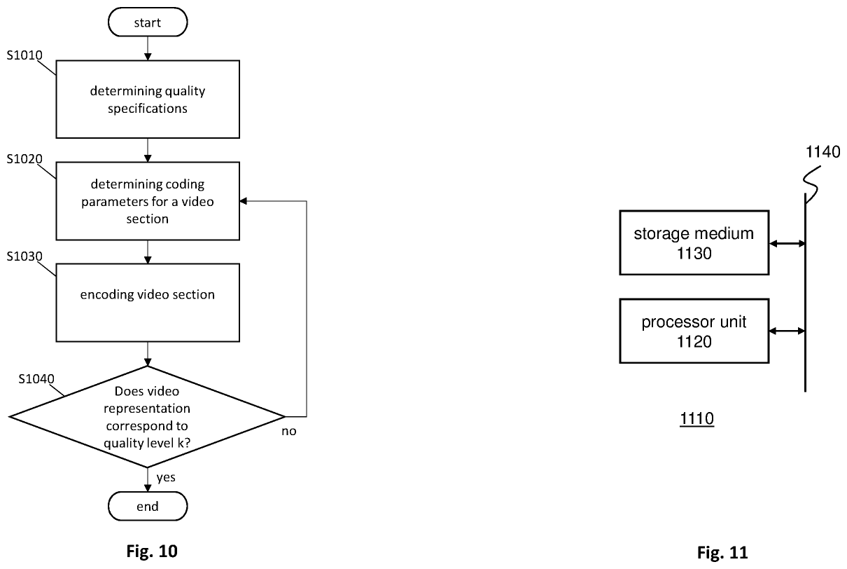

Embodiments of the present invention and their functions can be implemented in hardware, software, firmware, or a combination thereof, as shown by way of example in FIG. 11. When embodiments are implemented as software, the functions can be stored on a computer-readable storage medium 1130 or transmitted over a communications channel 1140 (e.g., a bus) as instructions or code to be executed by a hardware-based processing unit 1120. For example, a computer-readable storage medium 1130 can be RAM, ROM, EEPROM, CD-ROM, or other optical storage medium, a magnetic storage medium, a flash memory, or other storage medium that can be used to store program code in the form of instructions such that they can be read out by a computer.

Instructions can be executed by one or more processors, such as digital signal processors (DSP), general purpose microprocessors, application-specific integrated circuits, field-programmable gate arrays (FPGAs), or other integrated or discrete logic circuits. Accordingly, the term “processor” can refer to any of the structures mentioned or other structures suitable for implementing the methods described above. In addition, the functionalities described can be implemented in hardware and/or software modules provided for this purpose which are configured to encode and/or decode image data, also as part of a combined codec. The methods can also be implemented in one or more circuits or logic elements.

Processor 1120 can therefore implement device 110 or 120, or device 100 for determining a bit rate ladder.

A device for determining quality specifications for encoding representations of a video section comprises a unit that determines the maximum and minimum quality levels as described above, and a unit that determines the set of quality levels with the predefined maximum quality gap between adjacent quality levels as described above.

A device for encoding representations of a video section comprises a unit that determines the quality specifications as described above and a unit that determines one or more encoding parameters for each quality level in the set as described above.

In summary, the present invention relates to methods and devices for determining a set of quality levels and to encoding representations of a video section. Determining a set of quality levels for the respective associated representations of a video section takes special consideration of the resulting subjective quality during creation. This is described primarily by quality-based parameters. They are the highest and lowest quality and the quality level among the individual representations.

1. A method for determining quality specifications for encoding representations of a video section, comprising:
determining a maximum quality level and a minimum quality level based on a quality measure, where the quality measure is based on a comparison with an unimpaired reference; and
determining a set of quality levels for the respective associated representations of a video section, wherein the set of quality levels comprises two or more quality levels that maintain a predefined maximum quality gap between adjacent quality levels,
where the set of quality levels comprises a quality level above the maximum quality level and contains a quality level below the minimum quality level.

2. The method according to claim 1, where
the minimum quality level is determined based on an acceptance measure which indicates a minimum quality at which a predetermined number of viewers find the representation associated with the minimum quality to be acceptable.

3. The method according to claim 1, where
the maximum quality level is determined based on a quality at which a predetermined number of viewers cannot distinguish the representation corresponding to the quality from an original representation.

4. The method according to claim 1, where
a minimum number of quality levels is determined by the maximum quality level, the minimum quality level, and the maximum quality gap.

5. The method according to claim 1, where
adjacent quality levels that differ by the maximum quality gap are classified as being subjectively equal by a predetermined number of viewers.

6. The method according to claim 1, where
the quality measure is an estimate of a subjective video metric.

7. The method according to claim 1, where
the quality measure is a Video Multi-Method Assessment Fusion (VMAF) metric.

8. The method according to claim 1, where
the maximum quality gap in the VMAF metric is 2; and/or
the maximum quality level in the VMAF metric is 95; and/or
the minimum quality level in the VMAF metric is 55.

9. The method according to claim 1, further comprising:
determining one or more encoding parameters for each quality level in the set such that the representation of a video section, after encoding with one or more encoding parameters, substantially reaches the quality level associated with the representation of the video section.

10. A computer program comprising: program instructions which are stored on a non-transitory computer-readable medium and which, when executed on one or more processors, cause the one or more processors to perform the steps of the method of claim 1.

11. A device for determining quality specifications for encoding representations of a video section, comprising:
a unit for determining a maximum quality level and a minimum quality level based on a quality measure, where the quality measure is based on a comparison with an unimpaired reference; and
a unit for determining a set of quality levels for the respective associated representations of a video section, wherein the set of quality levels comprises two or more quality levels that maintain a predefined maximum quality gap between adjacent quality levels,
where the set of quality levels comprises a quality level above the maximum quality level and contains a quality level below the minimum quality level.

12. A device for encoding representations of a video section, comprising:
the device according to claim 11; and
a unit for determining one or more encoding parameters for each quality level in the set such that the representation of a video section, after encoding with one or more encoding parameters, substantially reaches the quality level associated with the representation of the video section.
